(19) United States
(12) Patent Application Publication
(10) Pub. No.: US 2019/0173822 A1
(43) Pub. Date: Jun. 6, 2019

(54) LOCATION INTELLIGENCE TO SEARCH AND ORGANIZE TEXTUAL MESSAGES

(71) Applicants: Murali P. Pidathala, San Jose, CA (US); Ravindra B. Gudapati, Saratoga, CA (US); Suneel Nulu, San Jose, CA (US)

(72) Inventors: Murali P. Pidathala, San Jose, CA (US); Ravindra B. Gudapati, Saratoga, CA (US); Suneel Nulu, San Jose, CA (US)

(21) Appl. No.: 15/828,672

(22) Filed: Dec. 1, 2017

(51) Int. Cl. H04L 12/58

(52) U.S. Cl. CPC H04L 51/20; H04L 51/12; H04L 51/08; H04L 51/32

(57) ABSTRACT

A computer implemented method and a system for assigning a location to a not exceeding 140-character textual post for retrieving user generated textual posts, includes: associating a location tag with the 140-character textual post within one or more communities, each community having a specific geographical location and social context; storing the associated location tag and 140-character textual post in one or more databases; searching the one or more databases for one or more other associated location tagged 140-character textual posts; and displaying the one or more other associated location tagged 140-character textual posts.

### FIELD OF THE INVENTION

The disclosure generally relates to information-networked communities, and more particularly to using location intelligence to search and organize user generated textual messages within one or more information-networked local communities by a user's choice of location or radial distance.

### BACKGROUND OF THE INVENTION

Most traditional social media applications such as Facebook, LinkedIn and Google+primarily focus on sharing content and posting comments within the specified social distance of a specific user's network and also facilitate connecting to individuals. As such, today's social applications freely allow users to express and publish content in various formats. However, the challenge remains with regards to how to use location intelligence to search and organize user generated textual messages within one or more information-networked local communities by a user's choice of location or radial distance.

### SUMMARY OF THE INVENTION

In one embodiment, the disclosure provides a computer implemented method and system for assigning a location to a not exceeding 140-character textual post for retrieving user generated textual posts, which includes: associating a location tag with the 140-character textual post within one or more communities, each community having a specific geographical location and social context; storing the associated location tag and 140-character textual post in a community specific database; searching the one or more community specific databases for one or more other associated location tagged 140-character textual posts; and displaying the one or more other associated location tagged 140-character textual posts.

In another embodiment, the disclosure provides a computer implemented method and system for assigning a location to a not exceeding 140-character textual post for retrieving user generated textual posts, wherein the content search is based on the user's choice of named location or on a radial distance from the location.

In another embodiment, the disclosure provides a computer implemented method and system for assigning a location to a not exceeding 140-character textual post for retrieving user generated textual posts, wherein the 140-character textual post falls within a category of a SAY, an ASK, an UPDATE, or a HASHTAG with its associated #SAYs

In another embodiment, the disclosure provides a computer implemented method and system for assigning a location to a not exceeding 140-character textual post for retrieving user generated textual posts, wherein each location tag is based on a user's exact geographical coordinates, a nearby user's named location, or any other named location selected by the user.

In another embodiment, the disclosure provides a computer implemented method and system for assigning a location to a not exceeding 140-character textual post for retrieving user generated textual posts, wherein each associated location tag and 140-character textual post is stored in a community specific database.

In another embodiment, the disclosure provides a computer implemented method and system for assigning a location to a not exceeding 140-character textual post for retrieving user generated textual posts, wherein each associated location tag for 140-character textual post is assigned a named location and/or a pair of latitude and longitude geographical coordinates.

In another embodiment, the disclosure provides a computer implemented method and system for assigning a location to a not exceeding 140-character textual post for retrieving user generated textual posts, wherein each user has an ability to search and view each associated location tagged 140-character textual posts from the one or more databases by a named location as chosen by a user.

In another embodiment, the disclosure provides a computer implemented method and system for assigning a location to a not exceeding 140-character textual post for retrieving user generated textual posts, wherein each user has an ability to define a range in miles or meters for searching and viewing the associated location tagged 140-character text messages from the one or more databases.

In another embodiment, the disclosure provides a computer implemented method and system for assigning a location to a not exceeding 140-character textual post for retrieving user generated textual posts, wherein each user has an ability to search and view all associated location tagged 140-character textual posts in the one or more databases within a radial range as defined by the user.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, size, or applicability of the disclosure. It should be noted that for clarity and ease of illustration these drawings are not necessarily made to scale.

FIG. 1 illustrates an embodiment of a method for developing an information-networked local community in which the user can search and view HASHTAGs from various communities using a specific Location Tag, “SANTA CLARA UNIVERSITY”;

FIG. 2 illustrates an embodiment of a method for developing an information-networked local community in which the user can search and view HASHTAGs within a single community using a specific Location Tag, “AMERICAN CANCER SOCIETY”;

FIG. 3 illustrates an embodiment of a method for developing an information-networked local community in which the user can search and organize all message categories using a “Nearby” feature in a plurality of communities;

FIG. 4 illustrates an embodiment of a method for developing an information-networked local community in which the user can search and organize all message categories using a “Nearby” feature within a single community;

FIG. 5 illustrates an embodiment of a method for developing an information-networked local community in which the user can search and view SAYS (answers) posted to specific ASKS or relevant SAYs (matches) from a plurality of communities using “find nearby” function when posting a new ASK; The vice versa aspect in which the user can search and view ASKs made open to a community from a plurality of communities using, “find nearby” function when posting a new SAY is possible.

FIG. 6 illustrates an embodiment of a method for developing an information-networked local community in which the user can select the “Tag” option to tag a location for the message being posted;

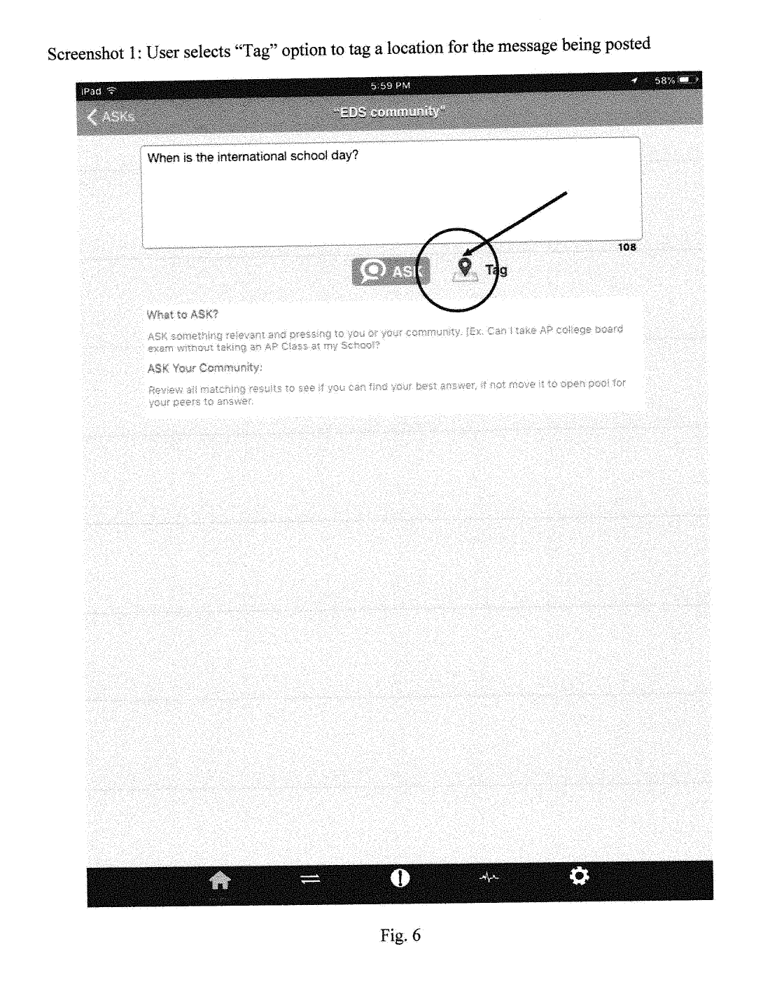

FIG. 7 illustrates an embodiment of a method for developing an information-networked local community that displays a default geographic map for the user to tag (select) a location to the message;

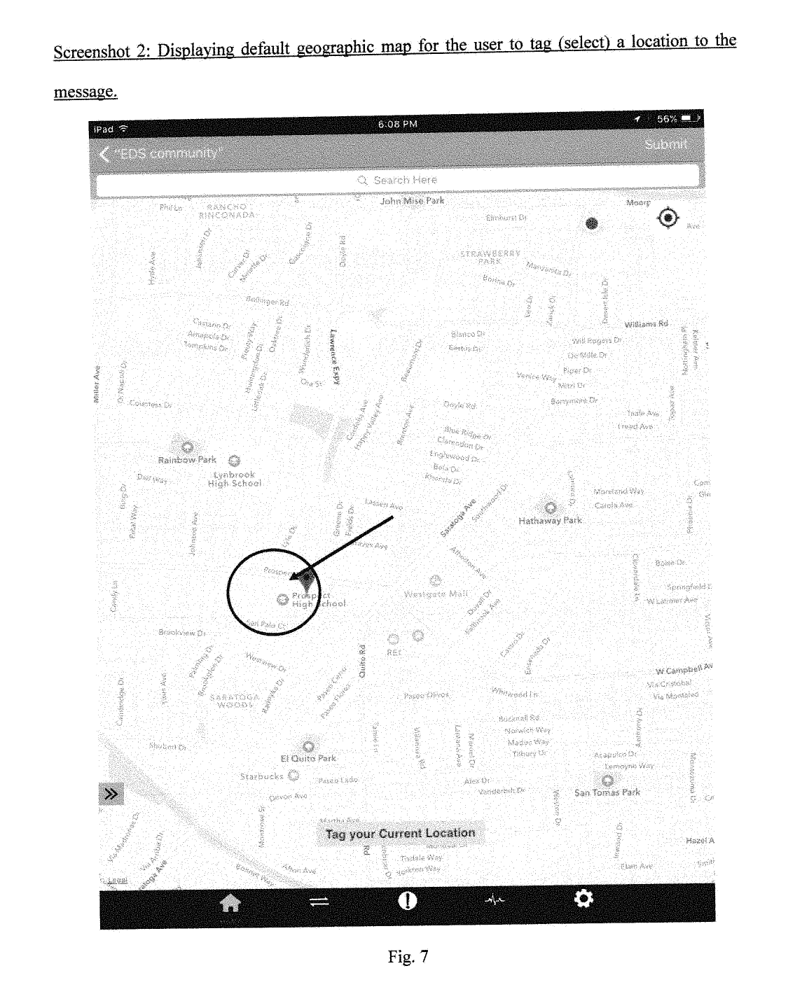

FIG. 8 illustrates an embodiment of a method for developing an information-networked local community that displays a “View” option to either view or edit a location tagged to a message; and

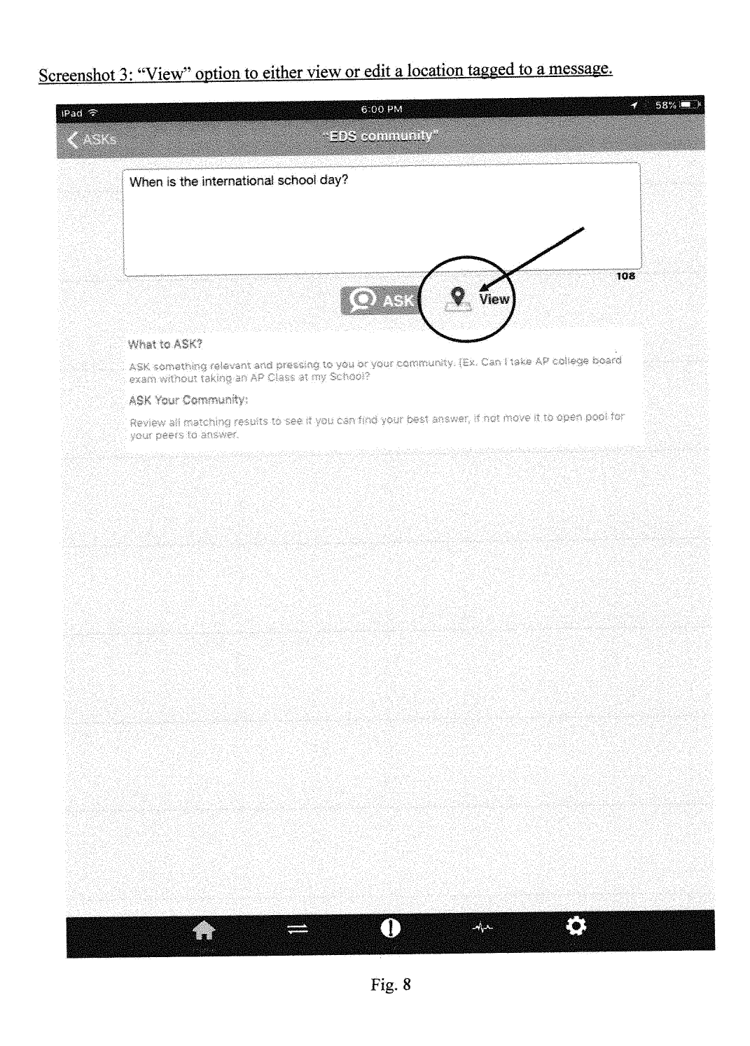

FIG. 9 illustrates an embodiment of a method for developing an information-networked local community that displays locations tagged to messages.

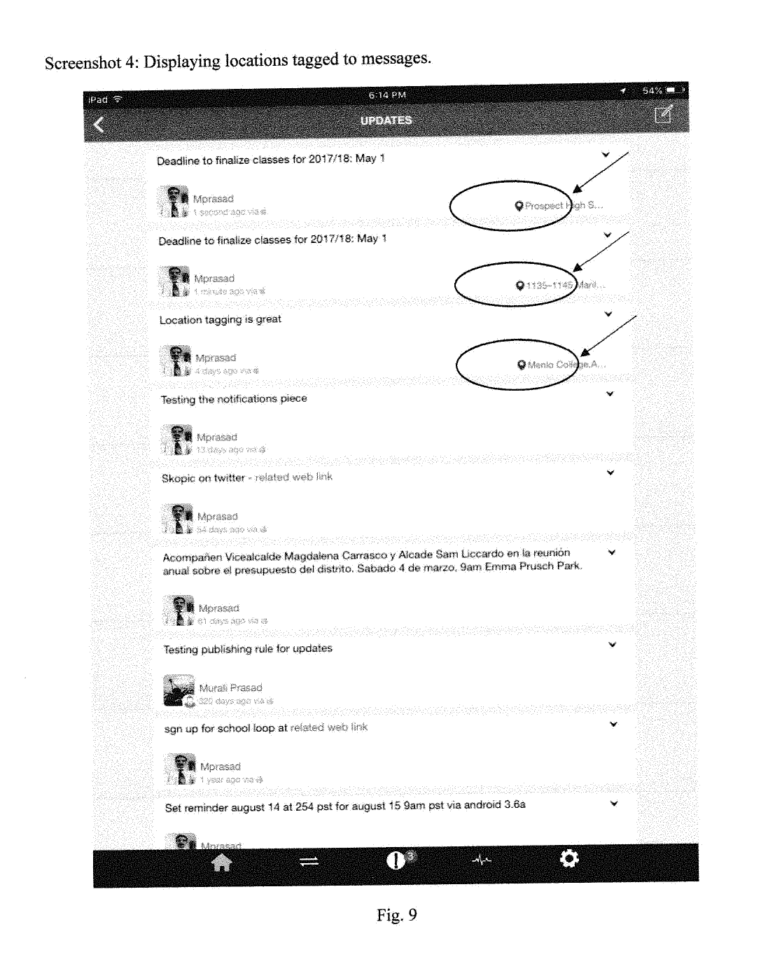

### DETAILED DESCRIPTION OF THE EMBODIMENTS

The following description is presented to enable a person of ordinary skill in the art to make and use embodiments described herein. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the disclosure. Thus, the present disclosure is not intended to be limited to the examples described herein and shown, but is to be accorded the scope consistent with the claims.

It should be understood that the specific order or hierarchy of steps in the process disclosed herein is an example of exemplary approaches. Based upon design preferences, it is understood that the specific order or hierarchy of steps in the processes may be rearranged while remaining within the scope of the present disclosure. Any accompanying method claims present elements of the various steps in a sample order, and are not meant to be limited to the specific order or hierarchy presented.

The present invention, relates to a social platform for developing informed communities, which can be either hyper local or super focused within a specific geographical location. The social information created within the system can be organized, mined and delivered to other community peers seeking information about important and time critical daily matters.

Since these communities are organized around common interests, geographical location and/or goals, the participants benefit from the information shared by their community peers. Further details involving this social platform can be found in U.S. Pat. No. 9,690,874, the entire disclosure of which is hereby incorporated by reference in its entirety for all purposes.

In the present disclosure, there is provided a platform or system for developing information-networked local communities. The system develops and organizes a not exceeding 140-character textual message, namely an ASKS, SAYS, UPDATES and HASHTAGS within one or more communities each having a specific geographic and social context. Such content is stored in community specific data store or database, that can be further searched and retrieved, when any user posts a SAY or an ASK.

The purpose of developing this system is to develop a functionality wherein the content can be searched and organized by location within and across the above stated message categories. This will help users connect with relevant content by location tag at one instance and avoids users looking for content in adiscrete manner either within a single or plurality of online communities.

Different use case scenarios for this invention are presented hereafter.

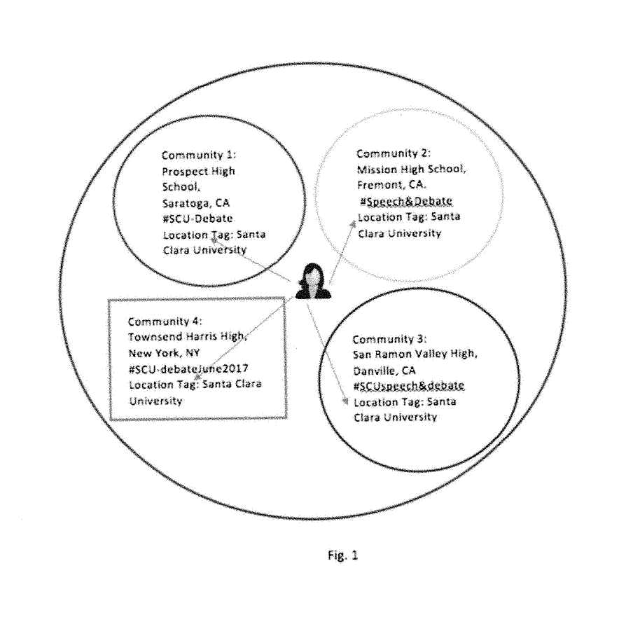

USE CASE 1: The user will be able to search and view HASHTAGS from various communities using a specific Location Tag, SANTA CLARA UNIVERSITY. Refer to FIG. 1 for a visual depiction.

Sample Search Results:

#SCU-Debate and all associated posts, from community 1

#SCU-Speech&Debate and all associated posts, from community 2

#SCUspeech&debate, and all associated posts, from community 3

#SCU-debateJune 2017 and all associated posts, from community 4

From the results above, it can be noted all Hashtag posts from 4 different communities are searched and viewed by a location tag named “SANTA CLARA UNIVERSITY”.

The same use case is extended for searching and viewing other message categories, namely; ASKS, SAYS and UPDATES.

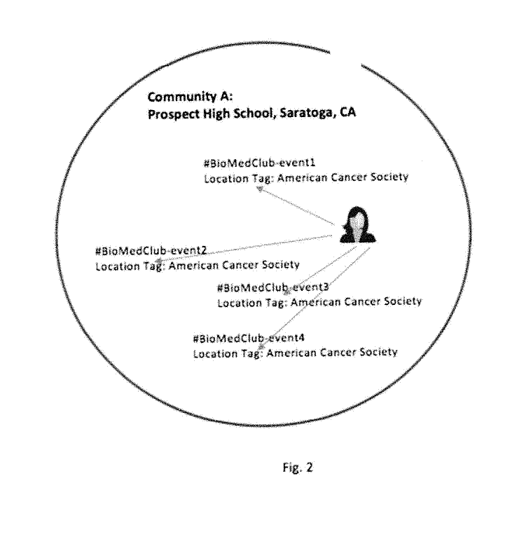

USE CASE 1A: The user will be able to search and view HASHTAGS within a single community using a specific Location Tag named, AMERICAN CANCER SOCIETY: Refer to FIG. 2 for visual depiction.

Sample Search Results:

#BioMedClub-event1 and all associated posts, from community A

#BioMedClub-event2 and all associated posts, from community A

#BioMedClub-event3 and all associated posts, from community A

#BioMedClub-event4 and all associated posts, from community A

From the results above, it can be noted all Hashtag posts within a single community is searched and viewed by a single location tag named “AMERICAN CANCER SOCIETY”.

The same use case is extended for searching and viewing other message categories, namely; ASKS, SAYS and UPDATES.

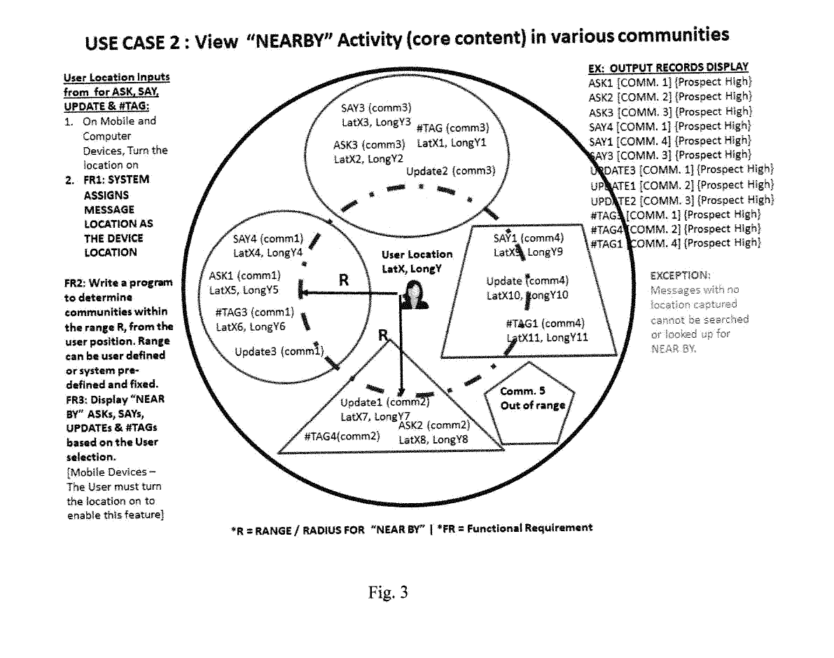

USE CASE 2: The user will be able to Search and organize all message categories using, “Nearby” feature: In this scenario, the user is able to define the radial range, R, in which the search can be performed for selected message categories namely; ASKS, SAYS, UPDATES and HASHTAGS in plurality of communities. This feature allows the user to view, “Nearby” activity on online sites. Refer to FIG. 3 for visual depiction.

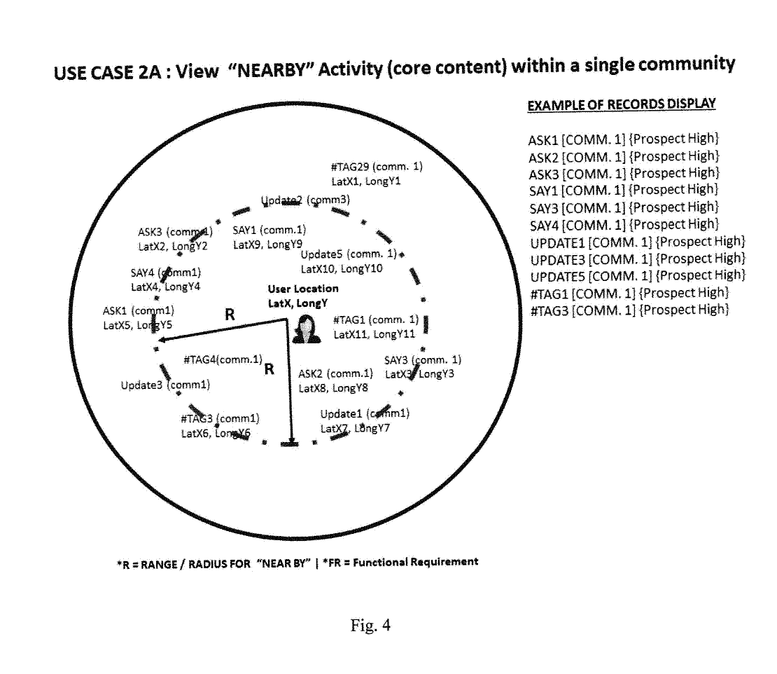

USE CASE 2A: The user will be able to Search and organize all message categories using, “Nearby” feature: In this scenario, the user is able to define the radial range, R, in which the search can be performed for selected message categories namely; ASKS, SAYS, UPDATES and HASHTAGS within a single community. This feature allows the user to view all, “Nearby” activity in a single community. Refer to FIG. 4 for visual depiction.

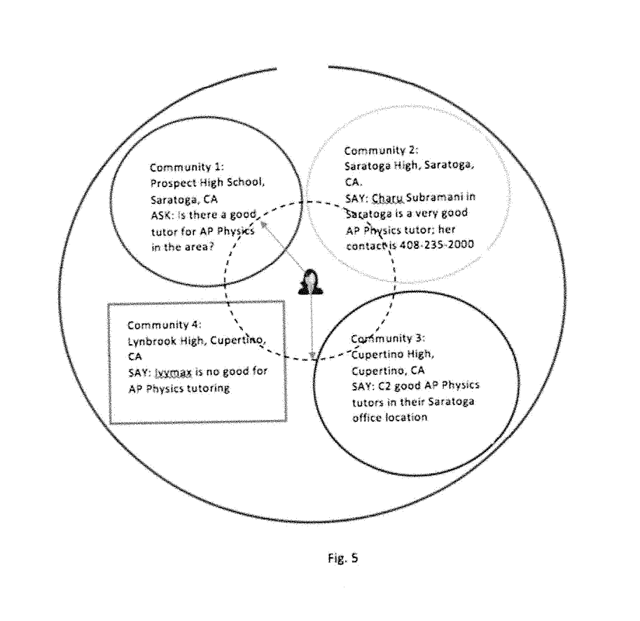

USE CASE 3: Find “Nearby” SAYS or ASKS. The user will have the ability to search and view SAYS posted to specific ASKS or ASKS made open to community, in plurality of communities, by opting to have the system perform such function. Refer to FIG. 5 visual depicts finding nearby SAYs (SAYS matching to the new ASK being posted) The same “Nearby” function is extended to search the SAYS (answers) posted to specific ASKS similar to the new ASK being posted and also for searching ASKs that may be similar to a new SAY being posted by the user.

### EXAMPLE

Step1: The ASK being posted in Community 1: Is there a good tutor for AP Physics in the area?

Step2: The user selects option to find “Nearby” SAYS [Answers] posted to the same or similar ASKS.

Step3: The system runs the search in communities that fall within the “Nearby” range of the user, and displays all matching results.

The results for “Nearby” feature will look like as shown below:

Charu Subramani in Saratoga is a very good AP Physics tutor, her contact is 408-235-2000 [searched and retrieved from community 2]

C2 good AP Physics tutors in their Saratoga office location [searched and retrieved from community 3]

Ivymax is no good for AP Physics tutoring [searched and retrieved from community 4].

While the inventive features have been particularly shown and described with reference to preferred embodiments thereof, it will be understood by those in the art that the foregoing and other changes may be made therein without departing from the sprit and the scope of the disclosure. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

What is claimed is:

1. A computer implemented method of assigning a location to a not exceeding 140-character textual post for retrieving user generated textual posts, comprising
associating a location tag with the 140-character textual post within one or more communities,
each community having a specific geographical location and social, context;
storing the associated location tag and 140-character textual post in a community specific database;
searching the one or more databases for one or more other associated location tagged 140-character textual posts; and
displaying the one or more other associated location tagged 140-character textual posts.

2. The computer implemented method of claim 1, wherein the location tag for content search is based on the user's choice of a named location or on a radial distance from the user's geographic coordinates (a pair of latitude and longitude)

3. The computer implemented method of claim 1, wherein the 140-character textual post falls within a category of a SAY, an ASK, an, UPDATE, or a HASHTAG.

4. The computer implemented method of claim 1, wherein each location tag is based on a user's exact geographical latitude and longitude coordinates, a nearby user's geographical named location, or any other geographical named location as may be selected by the user.

5. The computer implemented method of claim 1, wherein each associated location tag and 140-character textual post is stored in a community specific database.

6. The computer implemented method of claim 1, wherein each associated location tag for a 140-character textual post assigned is a geographical named location or a pair of latitude and longitude geographical coordinates.

7. The computer implemented method of claim 1, wherein each user has an ability to search and view all associated location tagged 140-character textual posts from the one or more databases through a named location as chosen by a user.

8. The computer implemented method of claim 1, wherein each user has an ability to define a range in miles or meters for searching and viewing the associated location tagged 140-character text messages from the one or more community specific databases.

9. The computer implemented method of claim 2, wherein each user has an ability to search and view all associated location tagged 140-character textual posts in the one or more community specific databases within a radial range as defined by the user.

10. The computer implemented method of claim 2, wherein each user has an ability to search and view “Nearby” SAYS and “Nearby” SAYS posted to specific ASKS in the one or more community specific databases within a radial range as defined by the user that only match to a new ASK being posted within a specific community.

11. The computer implemented method of claim 2, wherein each user has an ability to search and view “Nearby” ASKS in the one or more community specific databases within a radial range as defined by the user that only match to a new SAY being posted within a specific community.

12. The computer implemented method of claim 2, wherein each user has an ability to search and view a specific category of associated location tagged 140-character textual posts in the one or more community specific databases within a radial range as defined by the user or by a named location specified by the user.
